(19) United States
(12) Patent Application Publication
(10) Pub. No.: US 2024/0302973 A1
(43) Pub. Date: Sep. 12, 2024

(54) PROTECTED VIRTUAL PARTITIONS IN NON-VOLATILE MEMORY STORAGE DEVICES WITH HOST-CONFIGURABLE ENDURANCE

(71) Applicant: Micron Technology, Inc., Boise, ID (US)

(72) Inventor: Christopher Joseph BUEB, Folsom, CA (US)

(21) Appl. No.: 18/584,635

(22) Filed: Feb. 22, 2024

Related U.S. Application Data
(60) Provisional application No. 63/488,690, filed on Mar. 6, 2023.

(51) Int. Cl. G06F 3/06

(52) U.S. Cl. CPC G06F 3/0616; G06F 3/0644; G06F 3/0679

(57) ABSTRACT

A system includes a non-volatile memory configured with a wear-leveling media pool, and a controller. The wear-leveling media pool has an initial endurance limit and is divided into a plurality of virtual partitions. Each virtual partition is assigned a respective endurance threshold. The controller is configured to monitor a first endurance parameter for each virtual partition based on the first endurance parameter for a respective virtual partition satisfying or not satisfying the respective endurance threshold of the respective virtual partition, evaluate a second endurance parameter of the wear-leveling media pool, determine to increase the initial endurance limit of the wear-leveling media pool by an additional endurance amount based on the second endurance parameter satisfying a parameter threshold, and allocate the additional endurance amount among one or more virtual partitions of the plurality of virtual partitions to increase the respective endurance threshold of the one or more virtual partitions.

### CROSS REFERENCE TO RELATED APPLICATION

This Patent Application claims priority to U.S. Provisional Patent Application No. 63/488,690, filed on Mar. 6, 2023, and entitled “PROTECTED VIRTUAL PARTITIONS IN NON-VOLATILE MEMORY STORAGE DEVICES WITH HOST-CONFIGURABLE ENDURANCE.” The disclosure of the prior Application is considered part of and is incorporated by reference into this Patent Application.

### TECHNICAL FIELD

The present disclosure generally relates to memory devices, memory device operations, and, for example, to protected virtual partitions in non-volatile memory (NVM) storage devices with host-configurable endurance.

### BACKGROUND

A non-volatile memory device, such as a NAND memory device, may use circuitry to enable electrically programming, erasing, and storing of data even when a power source is not supplied. Non-volatile memory devices may be used in various types of electronic devices, such as computers, mobile phones, or automobile computing systems, among other examples.

A non-volatile memory device may include an array of memory cells, a page buffer, and a column decoder. In addition, the non-volatile memory device may include a control logic unit (e.g., a controller), a row decoder, or an address buffer, among other examples. The memory cell array may include memory cell strings connected to bit lines, which are extended in a column direction.

A memory cell, which may be referred to as a “cell” or a “data cell,” of a non-volatile memory device may include a current path formed between a source and a drain on a semiconductor substrate. The memory cell may further include a floating gate and a control gate formed between insulating layers on the semiconductor substrate. A programming operation (sometimes called a write operation) of the memory cell is generally accomplished by grounding the source and the drain areas of the memory cell and the semiconductor substrate of a bulk area, and applying a high positive voltage, which may be referred to as a “program voltage,” a “programming power voltage,” or “VPP,” to a control gate to generate Fowler-Nordheim tunneling (referred to as “F-N tunneling”) between a floating gate and the semiconductor substrate. When F-N tunneling is occurring, electrons of the bulk area are accumulated on the floating gate by an electric field of VPP applied to the control gate to increase a threshold voltage of the memory cell.

An erasing operation of the memory cell is concurrently performed in units of sectors sharing the bulk area (referred to as “blocks”), by applying a high negative voltage, which may be referred to as an “erase voltage” or “Vera,” to the control gate and a configured voltage to the bulk area to generate the F-N tunneling. In this case, electrons accumulated on the floating gate are discharged into the source area, so that the memory cells have an erasing threshold voltage distribution.

Each memory cell string may have a plurality of floating gate type memory cells serially connected to each other. Access lines (sometimes called “word lines”) are extended in a row direction, and a control gate of each memory cell is connected to a corresponding access line. A non-volatile memory device may include a plurality of page buffers connected between the bit lines and the column decoder. The column decoder is connected between the page buffer and data lines.

### BRIEF DESCRIPTION OF THE DRAWINGS

FIG. 1 is a diagram illustrating an example system capable of protected virtual partitions in non-volatile memory (NVM) storage devices with host-configurable endurance.

FIG. 2 is a diagram of example components included in a memory device.

FIG. 3 is a diagram of an example of protected virtual partitions in NVM storage devices with host-configurable endurance.

FIG. 4 is a flowchart of an example method associated with protected virtual partitions in NVM storage devices with host-configurable endurance.

### DETAILED DESCRIPTION

Some types of memory may have endurance limits regarding a quantity of access operations (e.g., write operations, read operations, program operations, and/or erase operations) that may be performed on a memory cell before memory performance is reduced and/or failure starts to occur. For example, physical degradation of a memory cell (e.g., a flash memory cell or an electrically erasable programmable read only memory (EEPROM) cell, among other examples) may occur as access operations for the memory cell are accumulated. This physical degradation can lead to decreased memory performance and/or memory cell failure for the memory cell. In particular, the memory cell may wear out or stop reliably storing a memory state due to physical degradation once a sufficient quantity of access operations is accumulated.

In a memory device, some memory blocks of memory cells may be more frequently accessed relative to other memory blocks. This may lead to some memory cells degrading or wearing out more quickly than other memory cells. Some data types consume a higher concentration of access operations than other data types. As a result, some memory blocks of memory cells may be subjected to a higher concentration of access operations based on the data type that the memory blocks are configured to store. Accordingly, some memory cells of a memory device may wear out before memory cells of other, less accessed, memory blocks. As a result, logic states or data stored at those memory cells may become corrupted, and those memory cells may cease to reliably store logic states or data. In some use cases, such as automotive, the failure or wearing out of memory cells can result in the loss of critical system data for an associated vehicle, which can render the vehicle non-operational and can result in costly repairs to the vehicle for replacing the memory device. Memory failure in a vehicle may also create a safety issue.

Memory blocks may be configured into a media pool (e.g., a common media pool). For example, a controller may use firmware to define a media pool by designating a plurality of memory blocks to be associated with the media pool. The media pool may have a factory-guaranteed endurance limit regarding a quantity of access operations that may be performed by the media pool (e.g., a total number of access operations that the memory blocks of that media pool can handle) before memory performance of the media pool is at risk of being reduced and/or subject to failure. For example, the factory-guaranteed endurance limit may designate a quantity of program/erase cycles or a quantity of terabytes written (TBW) for the media pool. The factory-guaranteed endurance limit of the media pool is typically fixed. Once the factory-guaranteed endurance limit is exceeded, the media pool may become a read only or read accessible memory in which write operations are disabled to preserve the operability of the media pool.

Moreover, the media pool may be used to store system data (e.g., essential system data) associated with a host device and non-system data (e.g., application data corresponding to one or more applications) associated with the host device. For example, system data may be critical for an operation of the host device. Applications can consume a large quantity of access operations. Thus, a larger quantity of applications that a user decides to install can lead to a higher consumption rate of access operations. Depending on the user's utilization of applications, the media pool or part of the media pool may wear out prematurely, including portions of the media pool that store system data, which can render the whole system inoperable. A possible remedy is to utilize separate media pools for system data and non-system data. However, increasing a quantity of media pools can increase design complexity and cost, and/or reduce system performance. In addition, a media pool for non-system data would still be limited by a factory-guaranteed endurance limit that would eventually be reached due to a large quantity of access operations.

Some implementations described herein provide a single media pool with firmware that divides the media pool into virtual partitions. The media pool may be a wear-leveling media pool, which is a media pool to which wear-leveling techniques are applied by a controller to balance wear among memory blocks of the media pool. In addition, each virtual partition may have a configurable endurance limit based on an initial endurance limit of the media pool. For example, the initial endurance limit may be a factory-guaranteed endurance limit that is allocated to the virtual partitions of the media pool. Therefore, each virtual partition may be assigned a respective endurance threshold based on the initial endurance limit of the media pool. The respective endurance threshold of a virtual partition may be a quantity of access operations (e.g., program/erase cycles or TBW) that may be performed with the virtual partition before memory performance of the virtual partition is at risk of being reduced and/or subject to failure.

Moreover, the media pool may be used to store system data (e.g., essential system data) associated with a host device and non-system data (e.g., application data corresponding to one or more applications) associated with the host device. For example, system data may be critical for an operation of the host device. Some virtual partitions may be configured to store system data, and some virtual partitions may be configured to store non-system data. A controller may be configured to monitor a first endurance parameter for each virtual partition of the plurality of virtual partitions, which may include enabling read operations and write operations at a respective virtual partition based on the first endurance parameter for the respective virtual partition not satisfying the respective endurance threshold of the respective virtual partition, and disabling the write operations at the respective virtual partition based on the first endurance parameter for the respective virtual partition satisfying the respective endurance threshold of the respective virtual partition.

In addition, the controller may be configured to evaluate a second endurance parameter of the media pool, determine to increase the initial endurance limit of the wear-leveling media pool by an additional endurance amount based on the second endurance parameter satisfying a parameter threshold, and allocate the additional endurance amount among one or more virtual partitions of the plurality of virtual partitions to increase the respective endurance thresholds of the one or more virtual partitions. As a result, an endurance of the media pool can be increased beyond the initial endurance limit and the additional endurance can be allocated to one or more virtual partitions that would benefit most from the additional endurance. For example, the controller may allocate the additional endurance to one or more virtual partitions that consume a higher volume of access operations than some of the other virtual partitions of the media pool. For example, the controller may allocate the additional endurance to one or more virtual partitions that are used for storing non-system data, such as application data.

Furthermore, the controller may be configured to evaluate the media pool throughout the lifetime of the media pool to determine if the endurance limit of the media pool can be increased one or more times, such that additional endurance may be allocated to one or more virtual partitions on an iterative basis, depending on a health assessment of the media pool.

In this way, system data for critical functions of the host device that is not expected to change or is expected to change infrequently can be protected from exceeding an endurance limit such that these critical functions can be maintained for an increased lifespan as compared to a case where the data for these critical functions were to be intermixed in memory blocks that were also used for non-critical functions or non-critical data. In addition, non-system data for non-critical functions of the host device that is expected to change more frequently can be protected from exceeding an endurance limit by increasing the endurance limit based on an evaluation of the media pool. This may increase the useful life of the host device.

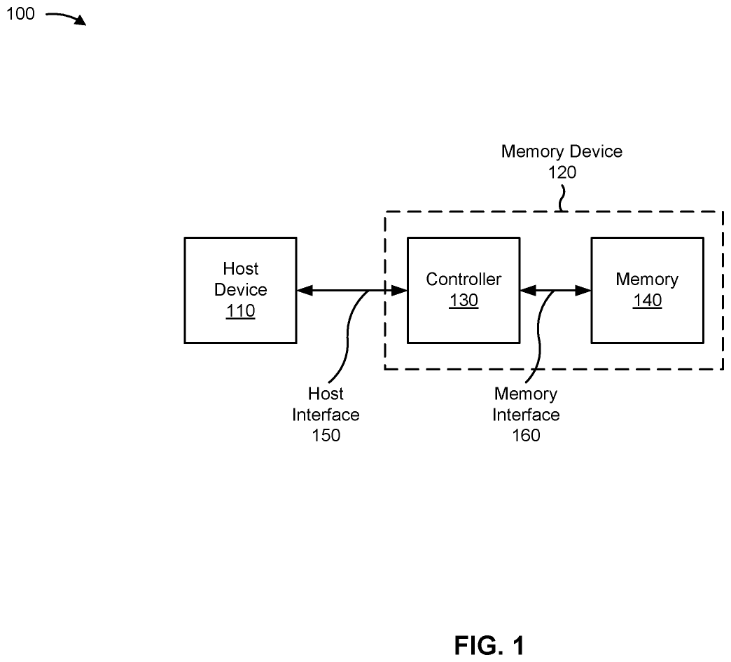

FIG. 1 is a diagram illustrating an example system 100 capable of protected virtual partitions in non-volatile memory storage devices with host-configurable endurance. The system 100 may include one or more devices, apparatuses, and/or components for performing operations described herein. For example, the system 100 may include a host device 110 and a memory device 120. The memory device 120 may include a controller 130 and memory 140. The host device 110 may communicate with the memory device 120 (e.g., the controller 130 of the memory device 120) via a host interface 150. The controller 130 and the memory 140 may communicate via a memory interface 160.

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host device 110 may include one or more processors configured to execute instructions and store data in the memory 140. For example, the host device 110 may include a central processing unit (CPU), a graphics processing unit (GPU), a field-programmable gate array (FPGA), an application-specific integrated circuit (ASIC), and/or another type of processing component.

The memory device 120 may be any electronic device or apparatus configured to store data in memory. In some implementations, the memory device 120 may be an electronic device configured to store data persistently in non-volatile memory. For example, the memory device 120 may be a hard drive, a solid-state drive (SSD), a flash memory device (e.g., a NAND flash memory device or a NOR flash memory device), a universal serial bus (USB) thumb drive, a memory card (e.g., a secure digital (SD) card), a secondary storage device, a non-volatile memory express (NVMe) device, and/or an embedded multimedia card (eMMC) device. In this case, the memory 140 may include non-volatile memory configured to maintain stored data after the memory device 120 is powered off. For example, the memory 140 may include NAND memory or NOR memory. In some implementations, the memory 140 may include volatile memory that requires power to maintain stored data and that loses stored data after the memory device 120 is powered off, such as one or more latches and/or random-access memory (RAM), such as dynamic RAM (DRAM) and/or static RAM (SRAM). For example, the volatile memory may cache data read from or to be written to non-volatile memory, and/or may cache instructions to be executed by the controller 130.

The controller 130 may be any device configured to communicate with the host device (e.g., via the host interface 150) and the memory 140 (e.g., via the memory interface 160). Additionally, or alternatively, the controller 130 may be configured to control operations of the memory device 120 and/or the memory 140. For example, the controller 130 may include control logic, a memory controller, a system controller, an ASIC, an FPGA, a processor, a microcontroller, and/or one or more processing components. In some implementations, the controller 130 may be a high-level controller, which may communicate directly with the host device 110 and may instruct one or more low-level controllers regarding memory operations to be performed in connection with the memory 140. In some implementations, the controller 130 may be a low-level controller, which may receive instructions regarding memory operations from a high-level controller that interfaces directly with the host device 110. As an example, a high-level controller may be an SSD controller, and a low-level controller may be a non-volatile memory controller (e.g., a NAND controller) or a volatile memory controller (e.g., a DRAM controller). In some implementations, a set of operations described herein as being performed by the controller 130 may be performed by a single controller (e.g., the entire set of operations may be performed by a single high-level controller or a single low-level controller). Alternatively, a set of operations described herein as being performed by the controller 130 may be performed by more than one controller (e.g., a first subset of the operations may be performed by a high-level controller and a second subset of the operations may be performed by a low-level controller).

The host interface 150 enables communication between the host device 110 and the memory device 120. The host interface 150 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, and/or an embedded multimedia card (eMMC) interface.

The memory interface 160 enables communication between the memory device 120 and the memory 140. The memory interface 160 may include a non-volatile memory interface (e.g., for communicating with non-volatile memory), such as a NAND interface or a NOR interface. Additionally, or alternatively, the memory interface 160 may include a volatile memory interface (e.g., for communicating with volatile memory), such as a double data rate (DDR) interface.

In some implementations, one or more systems, devices, apparatuses, components, and/or controllers of FIG. 1 may be associated with a non-volatile memory configured with a wear-leveling media pool comprising a plurality of memory blocks, wherein the wear-leveling media pool has an initial endurance limit, wherein the wear-leveling media pool is divided into a plurality of virtual partitions, and wherein each virtual partition of the plurality of virtual partitions is assigned a respective endurance threshold. Moreover, one or more controllers of FIG. 1 may be configured to monitor a first endurance parameter for each virtual partition of the plurality of virtual partitions, including enabling read operations and write operations at a respective virtual partition based on the first endurance parameter for the respective virtual partition not satisfying the respective endurance threshold of the respective virtual partition, and disabling the write operations at the respective virtual partition based on the first endurance parameter for the respective virtual partition satisfying the respective endurance threshold of the respective virtual partition; evaluate a second endurance parameter of the wear-leveling media pool; determine to increase the initial endurance limit of the wear-leveling media pool by an additional endurance amount based on the second endurance parameter satisfying a parameter threshold; and allocate the additional endurance amount among one or more virtual partitions of the plurality of virtual partitions to increase the respective endurance threshold of the one or more virtual partitions.

In some implementations, one or more systems, devices, apparatuses, components, and/or controllers of FIG. 1 may be associated with a non-volatile memory configured with a wear-leveling media pool comprising a plurality of memory blocks, wherein the wear-leveling media pool has an initial endurance limit, wherein the wear-leveling media pool is divided into a plurality of virtual partitions, including a first subset of one or more first virtual partitions configured to store system data associated with a host device and a second subset of one or more second virtual partitions configured to store non-system data associated with the host device, and wherein each virtual partition of the plurality of virtual partitions is assigned a respective endurance threshold. Moreover, one or more controllers of FIG. 1 may be configured to evaluate an endurance parameter of the wear-leveling media pool, determine to increase the initial endurance limit of the wear-leveling media pool by an additional endurance amount based on the endurance parameter satisfying a memory endurance condition of the wear-leveling media pool, and allocate the additional endurance amount to the second subset of one or more second virtual partitions to increase the respective endurance threshold of at least one of the one or more second virtual partitions.

In some implementations, one or more systems, devices, apparatuses, components, and/or controllers of FIG. 1 may be configured to determine that an endurance parameter associated with a wear-leveling media pool of the memory device satisfies a memory endurance condition of the wear-leveling media pool, wherein the wear-leveling media pool has an initial endurance limit, wherein the wear-leveling media pool is divided into a plurality of virtual partitions, including a first subset of one or more first virtual partitions configured to store system data associated with a host device and a second subset of one or more second virtual partitions configured to store non-system data associated with the host device, and wherein each virtual partition of the plurality of virtual partitions is assigned a respective endurance threshold; determine an additional endurance amount to be applied to the wear-leveling media pool in addition to the initial endurance limit based on the endurance parameter satisfying the memory endurance condition; and allocate the additional endurance amount to the second subset of one or more second virtual partitions to increase the respective endurance threshold of at least one of the one or more second virtual partitions.

As indicated above, FIG. 1 is provided as an example. Other examples may differ from what is described with regard to FIG. 1.

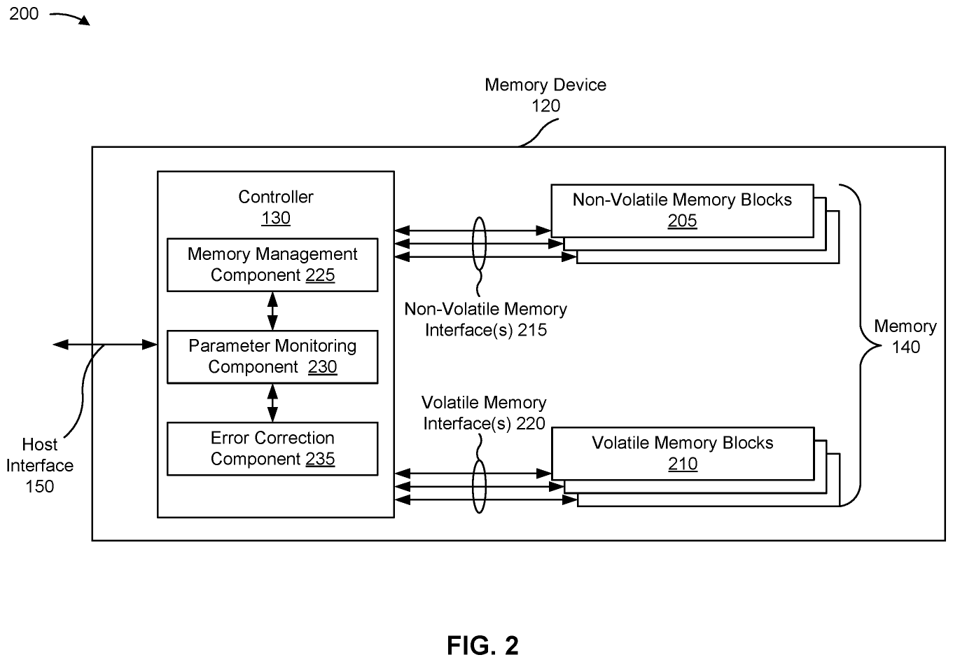

FIG. 2 is a diagram 200 of example components included in a memory device 120. As described above in connection with FIG. 1, the memory device 120 may include a controller 130 and memory 140. As shown in FIG. 2, the memory 140 may include one or more non-volatile memory blocks 205, such as one or more NAND memory blocks and/or one or more NOR memory blocks. Additionally, or alternatively, the memory 140 may include one or more volatile memory blocks 210, such as one or more SRAM blocks and/or one or more DRAM blocks. The controller 130 may transmit signals to and receive signals from a non-volatile memory block 205 using a non-volatile memory interface 215. The controller 130 may transmit signals to and receive signals from a volatile memory block 210 using a volatile memory interface 220.

The controller 130 may control operations of the memory 140, such as by executing one or more instructions. For example, the memory device 120 may store one or more instructions in the memory 140 as firmware, and the controller 130 may execute those one or more instructions. Additionally, or alternatively, the controller 130 may receive one or more instructions from the host device 110 via the host interface 150, and may execute those one or more instructions. In some implementations, a non-transitory computer-readable medium (e.g., volatile memory and/or non-volatile memory) may store a set of instructions (e.g., one or more instructions or code) for execution by the controller 130. The controller 130 may execute the set of instructions to perform one or more operations or methods described herein. In some implementations, execution of the set of instructions, by the controller 130, causes the controller 130 and/or the memory device 120 to perform one or more operations or methods described herein. In some implementations, hardwired circuitry is used instead of or in combination with the one or more instructions to perform one or more operations or methods described herein. Additionally, or alternatively, the controller 130 and/or one or more components of the memory device 120 may be configured to perform one or more operations or methods described herein. An instruction is sometimes called a “command.”

For example, the controller 130 may transmit signals to and/or receive signals from the memory 140 based on the one or more instructions, such as to transfer data to (e.g., write or program), to transfer data from (e.g., read), and/or to erase all or a portion of the memory 140 (e.g., one or more memory cells, pages, sub-blocks, blocks, or planes of the memory 140). Additionally, or alternatively, the controller 130 may be configured to control access to the memory 140 and/or to provide a translation layer between the host device 110 and the memory 140 (e.g., for mapping logical addresses to physical addresses of a memory block). In some implementations, the controller 130 may translate a host interface command (e.g., a command received from the host device 110) into a memory interface command (e.g., a command for performing an operation on a memory block).

As shown in FIG. 2, the controller 130 may include a memory management component 225, a parameter monitoring component 230, and/or an error correction component 235. In some implementations, one or more of these components are implemented as one or more instructions (e.g., firmware) executed by the controller 130. Alternatively, one or more of these components may be implemented as dedicated integrated circuits distinct from the controller 130.

The memory management component 225 may be configured to manage performance of the memory device 120. For example, the memory management component 225 may perform wear-leveling, bad block management, block retirement, read disturb management, and/or other memory management operations. In some implementations, the memory management component 225 may divide a wear-leveling media pool into a plurality of virtual partitions, including a first subset of one or more first virtual partitions configured to store system data associated with the host device 110 and a second subset of one or more second virtual partitions configured to store non-system data associated with the host device, and assign each virtual partition of the plurality of virtual partitions a respective endurance threshold based on an initial endurance limit of the wear-leveling media pool.

In some implementations, the memory management component 225 may enable read operations and write operations at a respective virtual partition based on a first endurance parameter for the respective virtual partition not satisfying the respective endurance threshold of the respective virtual partition, and disable write operations at the respective virtual partition based on the first endurance parameter for the respective virtual partition satisfying the respective endurance threshold of the respective virtual partition.

In some implementations, the memory management component 225 may determine to increase the initial endurance limit of the wear-leveling media pool by an additional endurance amount based on a second endurance parameter of the wear-leveling media pool satisfying a memory endurance condition of the wear-leveling media pool. For example, the memory management component 225 may determine to increase the initial endurance limit of the wear-leveling media pool by an additional endurance amount based on a second endurance parameter of the wear-leveling media pool satisfying a parameter threshold (e.g., whether the second endurance parameter is greater than a threshold, whether the second endurance parameter is less than a threshold, or whether the second endurance parameter satisfies some other threshold condition). Additionally, the memory management component 225 may allocate the additional endurance amount among one or more virtual partitions of the plurality of virtual partitions to increase the respective endurance thresholds of the one or more virtual partitions.

The parameter monitoring component 230 may be configured to monitor one or more endurance parameters to enable the memory management component 225 to perform one or more memory management operations. For example, the parameter monitoring component 230 may be configured to monitor a first endurance parameter for each virtual partition of the plurality of virtual partitions and compare the first endurance parameter for each virtual partition of the plurality of virtual partitions with the respective endurance threshold.

TBW is a measure of how many cumulative writes, in terabytes, have been completed or performed, and a TBW limit is how many cumulative writes a drive (e.g., a virtual partition or a media pool) can reasonably expect to complete over its lifespan. A program/erase cycle (P/E cycle) is a sequence of events in which data is written to a memory cell (e.g., solid-state NAND flash memory cell), a drive, a virtual partition, or media pool, and is subsequently erased and rewritten. A P/E cycle limit is how many cumulative P/E cycles a memory cell, a drive, a virtual partition, or a media pool can reasonably expect to complete over its lifespan. Accordingly, an endurance limit (e.g., an endurance threshold) of a virtual partition may be a TBW limit or a P/E cycle limit. The endurance limit for each virtual partition of the wear-leveling media pool is individually configurable, for example, by the memory management component 225, based on the initial endurance limit of the wear-leveling media pool. Accordingly, the first endurance parameter may be a quantity of TBW to a respective virtual partition or a quantity of program/erase cycles performed on a respective virtual partition. Moreover, the initial endurance limit of the wear-leveling media pool (e.g., an initial factory limit) may be an initial TBW limit or an initial P/E cycle limit.

In some implementations, the parameter monitoring component 230 may be configured to monitor the second endurance parameter of the wear-leveling media pool to enable the memory management component 225 to perform one or more memory management operations. For example, the parameter monitoring component 230 may be configured to monitor the second endurance parameter of the wear-leveling media pool and determine whether the second endurance parameter satisfies a memory endurance condition of the wear-leveling media pool. For example, the second endurance parameter may be a valley margin between pairs of adjacent programming distributions of the wear-leveling media pool. Alternatively, the second endurance parameter may be a total quantity of error detection and correction operations (e.g., a cumulative number of error detection and correction operations) performed on the wear-leveling media pool thus far. Alternatively, the second endurance parameter may be a total quantity of errors (e.g., a cumulative number of errors) detected within the wear-leveling media pool thus far.

The memory management component 225 may be configured to update the initial endurance limit of the wear-leveling media pool to an updated endurance limit by increasing the initial endurance limit of the wear-leveling media pool by the additional endurance amount based on the memory endurance condition of the wear-leveling media pool determined by the parameter monitoring component 230. In some implementations, the memory management component 225 may determine an amount of the additional endurance amount based on the memory endurance condition of the wear-leveling media pool determined by the parameter monitoring component 230. For example, the amount of the additional endurance amount may be selected by the memory management component 225 based on a difference between the second endurance parameter of the wear-leveling media pool and the parameter threshold. Thus, the memory management component 225 may be configured to allocate the additional endurance amount among one or more virtual partitions of the plurality of virtual partitions to increase the respective endurance threshold of the one or more virtual partitions based on the memory endurance condition of the wear-leveling media pool determined by the parameter monitoring component 230.

The error correction component 235 may be configured to detect and/or correct errors associated with the memory device 120. For example, the error correction component 235 may be configured to detect and/or correct an error associated with writing data to or reading data from one or more memory cells of the wear-leveling media pool, such as a single-bit error (SBE) or a multi-bit error (MBE). The parameter monitoring component 230 may monitor a quantity of error detection and correction operations performed on the wear-leveling media pool by the error correction component 235 for determining the memory endurance condition of the wear-leveling media pool. Alternatively, the parameter monitoring component 230 may monitor a total quantity of errors detected within the wear-leveling media pool by the error correction component 235 for determining the memory endurance condition of the wear-leveling media pool.

In some implementations, the memory device 120 may store (e.g., in memory 140) one or more memory management tables. A memory management table may store information that may be used by or updated by the memory management component 225, such as information regarding memory block age, memory block erase count, and/or error information associated with a memory partition (e.g., a memory cell, a row of memory, a block of memory, or the like). The memory management table may store each respective endurance threshold of each virtual partition of the wear-leveling media pool. The memory management table may store the initial endurance limit of the wear-leveling media pool and may store any adjustments made to the initial endurance limit as a result of an increase to the initial endurance limit made based on the second endurance parameter satisfying the memory endurance condition.

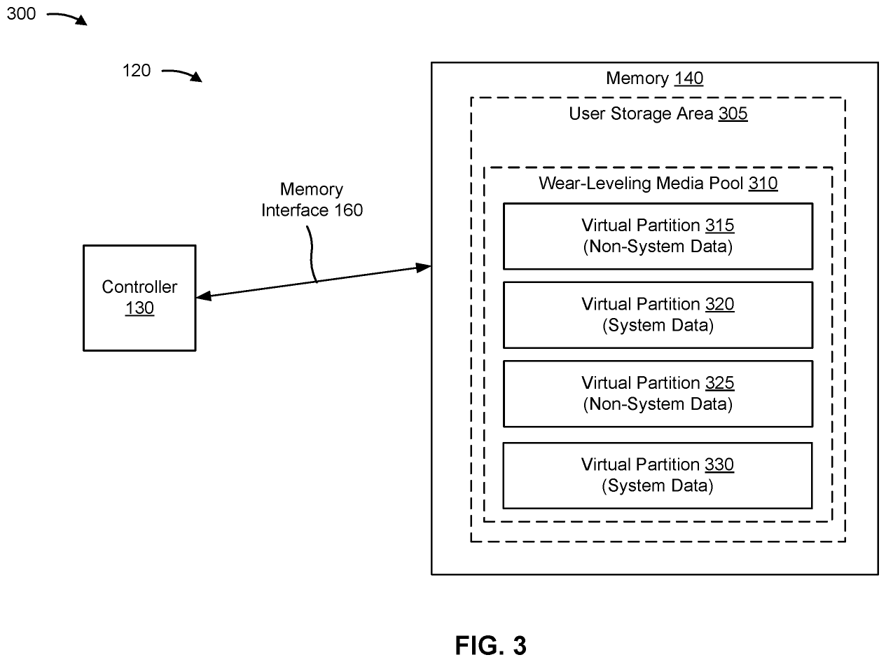

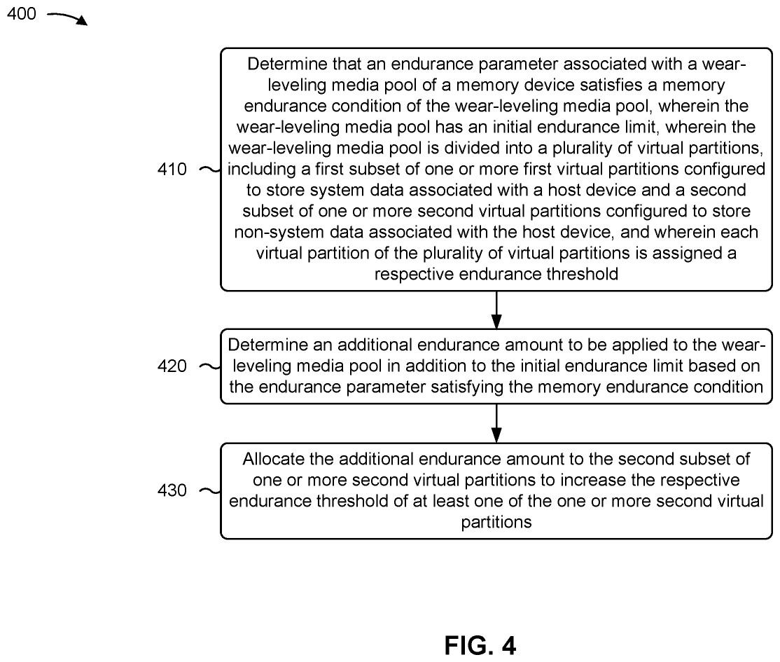

One or more devices or components shown in FIG. 2 may be configured to perform operations described herein, such as one or more operations and/or methods described in connection with FIGS. 3 and 4. For example, the controller 130, the memory management component 225, the parameter monitoring component 230, and/or the error correction component 235 may be configured to perform one or more operations and/or methods for the memory device 120.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

FIG. 3 is a diagram of an example 300 of protected virtual partitions in non-volatile memory storage devices with host-configurable endurance. The operations described in connection with FIG. 3 may be performed by the memory device 120 and/or one or more components of the memory device 120, such as the controller 130 and/or one or more components of the controller 130. As shown in FIG. 3, the example 300 may include the memory device 120, which includes the controller 130 and the memory 140. The controller 130 may access the memory 140 via the memory interface 160, as described herein.

As shown in FIG. 3, the controller 130 may use the memory interface 160 to configure a user storage area 305 in the memory 140. The user storage area 305 may include at least a portion of the non-volatile memory blocks 205 of the memory 140 (e.g., all of the non-volatile memory blocks 205 or a subset of the non-volatile memory block 205). For example, the user storage area 305 may include the non-volatile memory blocks 205 of the memory 140 that are usable by the host device 110 (e.g., that are host-addressable). Other storage areas of the memory 140 may be configured for and/or dedicated for system usage of the memory device 120, and may not be accessible to or modified by the host device 110 (e.g., may be non-host-addressable).

The memory cells of the non-volatile memory blocks 205 allocated to the user storage area 305 may have one or more characteristics, attributes, and/or properties. For example, the memory cells may be configured and/or used as single level cells (SLCs) and/or multiple level cells (MLCs). An SLC memory cell is a memory cell that selectively stores data in one of two possible states, where each state is associated with a respective voltage level or another respective parameter (e.g., a respective resistance and/or a respective magnetism). Accordingly, an SLC memory cell is configured to store one bit of data. As used herein, “MLC” refers to the storage of greater than one bit per memory cell. MLC encompasses and/or includes double level cell (DLC) memory cells (e.g., cells that are configured to store two bits of data per memory cell), triple level cell (TLC) memory cells (e.g., cells that are configured to store three bits of data per memory cell), quadruple level cell (QLC) memory cells (e.g., cells that are configured to store four bits of data per memory cell), pentad level cell (PLC) memory cells (e.g., cells that are configured to store five bits of data per memory cell), and memory cells that are configured to store more than five bits of data per memory cell. As another example, the memory cells may be written to and/or read from to emphasize certain parameters, such as endurance, read speed, write speed, and/or data retention, among other examples.

As further shown in FIG. 3, a group of non-volatile memory blocks 205 of the memory 140 may be assigned to a wear-leveling media pool 310, for example, by the controller 130. In particular, the wear-leveling media pool 310 includes a plurality of non-volatile memory blocks 205, for the user storage area 305, to which the controller 130 applies a wear-leveling algorithm. The wear-leveling algorithm may be applied to achieve even and consistent wearing of the non-volatile memory blocks 205 of the user storage area 305 (e.g., the non-volatile memory blocks 205 that are assigned to the wear-leveling media pool 310). In addition, the wear-leveling media pool 310 may be configured with an initial endurance limit (e.g., an initial TBW limit or an initial P/E cycle limit). For example, the wear-leveling media pool 310 may include 128 gigabytes (GB) of storage with an initial 3,000 P/E cycle limit. As a result, an initial TBW limit of the wear-leveling media pool 310 is 384 TBW (e.g., 128 GB×3,000 P/E cycles). The size of the wear-leveling media pool 310 and the initial endurance limit serves only as one possible example and other quantities and configurations are within the scope of the present disclosure.

In some implementations, the wear-leveling algorithm includes a static wear-leveling algorithm in which the non-volatile memory blocks 205 having the least amount of usage are used for a next write of data to the memory 140. In this way, the accumulation of access operations (e.g., write operations, read operations, program operations, and/or erase operations) is evenly incremented across the non-volatile memory blocks 205. The controller 130 (and/or the memory management component 225) may maintain a table or another type of database for tracking the accumulation of access operations for the non-volatile memory blocks 205 in the wear-leveling media pool 310.

In some implementations, the wear-leveling algorithm includes a dynamic wear-leveling algorithm. The dynamic wear-leveling algorithm may be similar to the static wear-leveling algorithm, except that the controller 130 additionally relocates data that is stored in relatively unused non-volatile memory blocks 205 (e.g., low usage non-volatile memory blocks 205 for which a frequency of access operations does not satisfy a threshold) to other non-volatile memory blocks 205 of the wear-leveling media pool 310. This enables the controller 130 to be used to store other (e.g., more frequently accessed and/or modified) data in the low usage non-volatile memory blocks 205 to increase the evenness of wearing in the wear-leveling media pool 310.

The wear-leveling media pool 310 may be divided into a plurality of virtual partitions, including a first virtual partition 315, a second virtual partition 320, a third virtual partition 325, and a fourth virtual partition 330. Each virtual partition of the plurality of virtual partitions 315, 320, 325, and 330 is assigned a different subset of logical memory addresses within the wear-leveling media pool 310. Thus, a virtual partition may be associated with a logical unit number (LUN) or another type of logical identifier.

A virtual partition may be configured for storing specific types of data and/or for general data storage. In other words, the plurality of virtual partitions 315, 320, 325, and 330 may be configured based on data type. For example, the plurality of virtual partitions 315, 320, 325, and 330 may include a first subset (e.g., one or more) of virtual partitions configured to store system data associated with the host device 110 and a second subset (e.g., one or more) of virtual partitions configured to store non-system data associated with the host device 110. For example, the second virtual partition 320 and the fourth virtual partition 330 may be configured to store system data associated with the host device 110, and the first virtual partition 315 and the third virtual partition 325 may be configured to store non-system data associated with the host device 110. The quantity of partitions and the types of data stored in the partitions in the example 300 are provided as an example, and other quantities and configurations are within the scope of the present disclosure.

Non-system data associated with the host device 110 may include, for example, user data, user applications or “apps,” a file system and associated data associated with an operating system for providing the user applications, user files, audio and/or video recordings, contact data, and/or other types of non-critical user data. System data associated with the host device 110 may include data that is needed for the host device 110 (or a system in which the host device 110 is included, such as a vehicle) to properly function. For example, system data may include a file system and associated data for a digital dashboard or a digital instrumentation panel of a vehicle, a file system and associated data for an in-vehicle infotainment system of the vehicle, operating system data associated with the host device 110, a mapping database for a digital navigation system of the vehicle, a point-of-interest database for the navigation system of the vehicle, and/or another type of critical data for the host device 110, among other examples.

Each virtual partition of the plurality of virtual partitions 315, 320, 325, and 330 may be individually assigned a respective endurance threshold (e.g., a respective TBW limit or a respective P/E cycle limit). Some or all of the respective endurance thresholds may be the same, or some or all of the respective endurance thresholds may be different. A weighted average of the respective endurance thresholds of the plurality of virtual partitions 315, 320, 325, and 330 may be equal to the initial endurance limit of the wear-leveling media pool 310. As one example out of many, the first virtual partition 315 may be assigned 16 GB with a respective endurance threshold of 5,000 P/E cycles (e.g., 16 GB×5,000 P/E cycles=80 TBW), the second virtual partition 320 may be assigned 48 GB with a respective endurance threshold of 1,000 P/E cycles (e.g., 48 GB×1,000 P/E cycles=48 TBW), the third virtual partition 325 may be assigned 32 GB with a respective endurance threshold of 6,000 P/E cycles (e.g., 32 GB×6,000 P/E cycles=192 TBW), and the fourth virtual partition 330 may be assigned 32 GB with a respective endurance threshold of 2,000 P/E cycles (e.g., 32 GB×2,000 P/E cycles=64 TBW). Accordingly, 80 TBW+48 TBW+192 TBW+64 TBW=384 TBW, which is the initial TBW limit of the wear-leveling media pool 310.

In some implementations, the controller 130 may be configured to form the wear-leveling media pool 310, divide the wear-leveling media pool 310 into the plurality of virtual partitions 315, 320, 325, and 330, assign a data type to each of the plurality of virtual partitions 315, 320, 325, and 330, and assign a respective endurance threshold to each of the plurality of virtual partitions 315, 320, 325, and 330.

In some implementations, the controller 130 may be configured to monitor a first endurance parameter for each virtual partition of the plurality of virtual partitions 315, 320, 325, and 330, and perform memory management operations on the plurality of virtual partitions 315, 320, 325, and 330 based on the first endurance parameter and the respective endurance thresholds. For example, the controller 130 may individually monitor the first endurance parameter for each virtual partition of the plurality of virtual partitions 315, 320, 325, and 330 and individually compare the first endurance parameter for each virtual partition with the respective endurance threshold assigned to a corresponding virtual partition.

The memory management operations may include enabling read operations and write operations at a respective virtual partition based on the first endurance parameter for the respective virtual partition not satisfying the respective endurance threshold of the respective virtual partition. For example, read operations and write operations may be enabled for a particular virtual partition as long as the first endurance parameter for the particular virtual partition is less than the respective endurance threshold of that particular virtual partition. Additionally, the memory management operations may include disabling the write operations at the respective virtual partition based on the first endurance parameter for the respective virtual partition satisfying the respective endurance threshold of the respective virtual partition. In other words, with write operations disabled, a virtual partition becomes a read-only partition. For example, write operations may be disabled for a particular virtual partition when the first endurance parameter for the particular virtual partition is equal to or greater than the respective endurance threshold of that particular virtual partition, in order to protect that particular virtual partition from data loss.

The controller 130 may be configured to evaluate the second endurance parameter of the wear-leveling media pool 310, determine to increase the initial endurance limit of the wear-leveling media pool 310 by an additional endurance amount based on the second endurance parameter satisfying a memory endurance condition (e.g., a parameter threshold), and allocate the additional endurance amount among one or more virtual partitions of the plurality of virtual partitions 315, 320, 325, and 330 to increase the respective endurance thresholds of the one or more virtual partitions.

For example, in some implementations, the controller 130 may determine that the initial endurance limit of the wear-leveling media pool 310 can be increased by an additional endurance amount if the valley margin between pairs of adjacent programming distributions of the wear-leveling media pool 310 is greater than a parameter threshold. In some implementations, the controller 130 may determine that the initial endurance limit of the wear-leveling media pool 310 can be increased by an additional endurance amount if a total quantity of error detection and correction operations performed on the wear-leveling media pool 310 is less than a parameter threshold. In some implementations, the controller 130 may determine that the initial endurance limit of the wear-leveling media pool 310 can be increased by an additional endurance amount if a total quantity of errors detected within the wear-leveling media pool 310 is less than a parameter threshold.

The memory endurance condition may be indicative of a health of the wear-leveling media pool 310 and/or indicative of a remaining lifetime of the wear-leveling media pool 310. For example, the controller 130 may be configured to evaluate the second endurance parameter of the wear-leveling media pool 310 by evaluating a memory endurance of the non-volatile memory blocks 205 allocated to the wear-leveling media pool 310. Thus, the controller 130 may evaluate any type of endurance parameter of the wear-leveling media pool 310 that may be indicative of whether the initial endurance limit of the wear-leveling media pool 310 can be increased. In some cases, the controller 130 may determine that the initial endurance limit of the wear-leveling media pool 310 cannot be increased and, as a result, the controller 130 may maintain the endurance limit of the wear-leveling media pool 310 at the initial endurance limit.

The controller 130 may be configured to update the initial endurance limit of the wear-leveling media pool 310 to an updated endurance limit by increasing the initial endurance limit of the wear-leveling media pool 310 by the additional endurance amount. The controller 130 may be configured to allocate the additional endurance

amount to only certain virtual partitions of the plurality of virtual partitions 315, 320, 325, and 330. As noted above, the plurality of virtual partitions 315, 320, 325, and 330 may include a first subset (e.g., one or more) of virtual partitions configured to store system data associated with the host device 110 and a second subset (e.g., one or more) virtual partitions configured to store non-system data associated with the host device 110. For example, the second virtual partition 320 and the fourth virtual partition 330 may be configured to store system data associated with the host device 110, and the first virtual partition 315 and the third virtual partition 325 may be configured to store non-system data associated with the host device 110. Accordingly, the controller 130 may be configured to allocate the additional endurance amount among the second subset of virtual partitions to increase the respective endurance threshold of at least one of the second subset of virtual partitions. In other words, the controller 130 may allocate the additional endurance amount to only those virtual partitions that store non-system data, such as application data, to extend the useful life of those virtual partitions that consume a higher volume of access operations prior to becoming a read-only partition. The controller 130 may allocate the additional endurance amount to a single virtual partition of the second subset of virtual partitions, to two or more virtual partitions of the second subset of virtual partitions, or to all of the virtual partitions of the second subset of virtual partitions. The controller 130 (e.g., the memory management component 225) may apply an allocation algorithm to determine which virtual partitions of the second subset of virtual partitions receive an increase in their respective endurance thresholds and by how much. The controller 130 may be configured to maintain the respective endurance threshold of each of the first subset of virtual partitions that store system data at a respective fixed value.

The controller 130 may be configured to allocate the additional endurance amount to the second subset of virtual partitions such that a weighted average of the respective endurance thresholds of the plurality of virtual partitions 315, 320, 325, and 330 matches a sum of the initial endurance limit and the additional endurance amount. For example, at 2,500 P/E cycles, the controller 130 may perform an evaluation on the wear-leveling media pool 310 and determine that the wear-leveling media pool 310 is capable of reliably performing an additional 1,500 P/E cycles beyond the 2,500 P/E cycles, which is 4,000 P/E cycles in total and 1,000 P/E cycles more than the initial endurance limit of 3,000 P/E cycles. Thus, in this example, the controller 130 may determine that the initial endurance limit can be increased by additional endurance amount of 1,000 P/E cycles (e.g., up to 4,000 P/E cycles). Still using 128 GB as an example size of the wear-leveling media pool 310, the additional endurance amount of 1,000 P/E cycles equates to an additional capability of 128 TBW (e.g., 128 GB×1,000 P/E cycles) that can be written to the wear-leveling media pool 310. The controller 130 may determine to allocate the additional endurance amount to the first virtual partition 315, to allocate the additional endurance amount to the third virtual partition 325, or to allocate the additional endurance amount among the first virtual partition 315 and the third virtual partition 325. In this example, the controller 130 allocates the third virtual partition 325 an additional 4,000 P/E cycles, which is a quantity determined based on the size of the third virtual partition 325 (e.g., 32 GB×4,000 P/E cycles=128 TBW, which is the same as the additional capability of 128 TBW allocated to the wear-leveling media pool 310). Due to the additional endurance amount determined by the controller 130, the initial endurance limit of the wear-leveling media pool 310 is increased to 4,000 P/E cycles and 512 TBW (e.g., 384 TBW+128 TBW). The values provided above are used merely as an example and other quantities and configurations are within the scope of the present disclosure.

The controller 130 may be configured to continue to monitor the first endurance parameter for each virtual partition of the plurality of virtual partitions based on the respective endurance threshold of each virtual partition of the plurality of virtual partitions 315, 320, 325, and 330, including based on any updated (e.g., increased) respective endurance thresholds.

In addition, the controller 130 may be configured to continue to monitor the second endurance parameter of the wear-leveling media pool 310 after the additional endurance amount has been allocated to the endurance limit of the wear-leveling media pool 310. For example, the additional endurance amount may be a first additional endurance amount, the updated endurance limit may be a first updated endurance limit, and the parameter threshold may be a first parameter threshold. Thus, subsequent to allocating the first additional endurance amount among the second subset of virtual partitions, the controller 130 may be configured to further evaluate the second endurance parameter of the wear-leveling media pool, determine to increase the initial endurance limit of the wear-leveling media pool by a second additional endurance amount based on the second endurance parameter satisfying a memory endurance condition (e.g., the first parameter threshold or a second parameter threshold), and allocate the second additional endurance amount among the second subset of virtual partitions to increase the respective endurance threshold of at least one of the second subset of virtual partitions. The controller 130 may allocate the second additional endurance amount to the first virtual partition 315, to the third virtual partition 325, or divide the second additional endurance amount between the first virtual partition 315 and the third virtual partition 325.

The controller 130 may be configured to update the first updated endurance limit to a second updated endurance limit by increasing the first updated endurance limit by the second additional endurance amount. Thus, the controller 130 may continue to increase the endurance limit of the wear-leveling media pool 310 periodically (e.g., on an iterative basis) when the controller 130 determines that the wear-leveling media pool 310 is capable of reliably performing an additional P/E cycle or write operations beyond the current endurance limit of the wear-leveling media pool 310. As a result, the controller 130 may evaluate a memory endurance condition of the wear-leveling media pool 310 throughout a lifetime of the wear-leveling media pool 310 to determine if the endurance limit of the wear-leveling media pool 310 can be increased. If so, additional cycles may be allocated to the virtual partitions containing non-system data to increase the endurance of those virtual partitions before those virtual partitions are reconfigured as read-only partitions. Moreover, a reliability of the virtual partitions that are configured for system data is maintained such that the host device 110 remains operable.

As indicated above, FIG. 3 is provided as an example. Other examples may differ from what is described with regard to FIG. 3.

FIG. 4 is a flowchart of an example method 400 associated with protected virtual partitions in NVM storage devices with host-configurable endurance. In some implementations, a controller of the memory device (e.g., the controller 130 of the memory device 120) may perform or may be configured to perform the method 400. In some implementations, another device or a group of devices separate from or including the controller of the memory device (e.g., the system 100) may perform or may be configured to perform the method 400 or part of the method 400. Additionally, or alternatively, one or more components of the controller of the memory device (e.g., the controller 130, the memory management component 225, the parameter monitoring component 230, and/or the error correction component 235) may perform or may be configured to perform the method 400. Thus, means for performing the method 400 may include the controller of the memory device and/or one or more components of the controller of the memory device. Additionally, or alternatively, a non-transitory computer-readable medium may store one or more instructions that, when executed by the controller of the memory device (e.g., the controller 130 of the memory device 120), cause the controller of the memory device to perform the method 400.

As shown in FIG. 4, the method 400 may include determining that an endurance parameter associated with a wear-leveling media pool of the memory device satisfies a memory endurance condition of the wear-leveling media pool (block 410). The wear-leveling media pool may have an initial endurance limit and may be divided into a plurality of virtual partitions, including a first subset of one or more first virtual partitions configured to store system data associated with a host device and a second subset of one or more second virtual partitions configured to store non-system data associated with the host device. Each virtual partition of the plurality of virtual partitions may be assigned a respective endurance threshold.

As further shown in FIG. 4, the method 400 may include determining an additional endurance amount to be applied to the wear-leveling media pool in addition to the initial endurance limit, based on the endurance parameter satisfying the memory endurance condition (block 420).

As further shown in FIG. 4, the method 400 may include allocating the additional endurance amount to the second subset of one or more second virtual partitions to increase the respective endurance threshold of at least one of the one or more second virtual partitions (block 430).

The method 400 may include additional aspects, such as any single aspect or any combination of aspects described below and/or described in connection with one or more other methods or operations described elsewhere herein.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

In some implementations, a system includes a non-volatile memory configured with a wear-leveling media pool comprising a plurality of memory blocks, wherein the wear-leveling media pool has an initial endurance limit, wherein the wear-leveling media pool is divided into a plurality of virtual partitions, and wherein each virtual partition of the plurality of virtual partitions is assigned a respective endurance threshold; and a controller configured to: monitor a first endurance parameter for each virtual partition of the plurality of virtual partitions, including enabling read operations and write operations at a respective virtual partition based on the first endurance parameter for the respective virtual partition not satisfying the respective endurance threshold of the respective virtual partition, and disabling the write operations at the respective virtual partition based on the first endurance parameter for the respective virtual partition satisfying the respective endurance threshold of the respective virtual partition, evaluate a second endurance parameter of the wear-leveling media pool, determine to increase the initial endurance limit of the wear-leveling media pool by an additional endurance amount based on the second endurance parameter satisfying a parameter threshold, and allocate the additional endurance amount among one or more virtual partitions of the plurality of virtual partitions to increase the respective endurance threshold of the one or more virtual partitions.

In some implementations, a system includes a non-volatile memory configured with a wear-leveling media pool comprising a plurality of memory blocks, wherein the wear-leveling media pool has an initial endurance limit, wherein the wear-leveling media pool is divided into a plurality of virtual partitions, including a first subset of one or more first virtual partitions configured to store system data associated with a host device and a second subset of one or more second virtual partitions configured to store non-system data associated with the host device, and wherein each virtual partition of the plurality of virtual partitions is assigned a respective endurance threshold; and a controller configured to: evaluate an endurance parameter of the wear-leveling media pool, determine to increase the initial endurance limit of the wear-leveling media pool by an additional endurance amount based on the endurance parameter satisfying a memory endurance condition of the wear-leveling media pool, and allocate the additional endurance amount to the second subset of one or more second virtual partitions to increase the respective endurance threshold of at least one of the one or more second virtual partitions.

In some implementations, a method includes determining, by a controller of a memory device, that an endurance parameter associated with a wear-leveling media pool of the memory device satisfies a memory endurance condition of the wear-leveling media pool, wherein the wear-leveling media pool has an initial endurance limit, wherein the wear-leveling media pool is divided into a plurality of virtual partitions, including a first subset of one or more first virtual partitions configured to store system data associated with a host device and a second subset of one or more second virtual partitions configured to store non-system data associated with the host device, and wherein each virtual partition of the plurality of virtual partitions is assigned a respective endurance threshold; determining, by the controller of the memory device, an additional endurance amount to be applied to the wear-leveling media pool in addition to the initial endurance limit based on the endurance parameter satisfying the memory endurance condition; and allocating, by the controller of the memory device, the additional endurance amount to the second subset of one or more second virtual partitions to increase the respective endurance threshold of at least one of the one or more second virtual partitions.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same clement (e.g., a+a, a+a+a, a+a+b, a+a+c, a+b+b, a+c+c, b+b, b+b+b, b+b+c, c+c, and c+c+c, or any other ordering of a, b, and c).

No clement, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system, comprising:
a non-volatile memory configured with a wear-leveling media pool comprising a plurality of memory blocks,
wherein the wear-leveling media pool has an initial endurance limit,
wherein the wear-leveling media pool is divided into a plurality of virtual partitions, and
wherein each virtual partition of the plurality of virtual partitions is assigned a respective endurance threshold; and
a controller configured to:
monitor a first endurance parameter for each virtual partition of the plurality of virtual partitions, including enabling read operations and write operations at a respective virtual partition based on the first endurance parameter for the respective virtual partition not satisfying the respective endurance threshold of the respective virtual partition, and disabling the write operations at the respective virtual partition based on the first endurance parameter for the respective virtual partition satisfying the respective endurance threshold of the respective virtual partition,
evaluate a second endurance parameter of the wear-leveling media pool,
determine to increase the initial endurance limit of the wear-leveling media pool by an additional endurance amount based on the second endurance parameter satisfying a parameter threshold, and
allocate the additional endurance amount among one or more virtual partitions of the plurality of virtual partitions to increase the respective endurance threshold of the one or more virtual partitions.

2. The system of claim 1, wherein the controller is configured to update the initial endurance limit of the wear-leveling media pool to an updated endurance limit by increasing the initial endurance limit of the wear-leveling media pool by the additional endurance amount.

3. The system of claim 2, wherein the additional endurance amount is a first additional endurance amount, the updated endurance limit is a first updated endurance limit, and the parameter threshold is a first parameter threshold,
wherein, subsequent to allocating the first additional endurance amount among the one or more virtual partitions, the controller is configured to:
evaluate the second endurance parameter of the wear-leveling media pool,
determine to increase the initial endurance limit of the wear-leveling media pool by a second additional endurance amount based on the second endurance parameter satisfying a second parameter threshold, and
allocate the second additional endurance amount among the one or more virtual partitions of the plurality of virtual partitions to increase the respective endurance threshold of the one or more virtual partitions.

4. The system of claim 3, wherein the controller is configured to update the first updated endurance limit to a second updated endurance limit by increasing the first updated endurance limit by the second additional endurance amount.

5. The system of claim 1, wherein the one or more virtual partitions are configured to store non-system data associated with a host device.

6. The system of claim 1, wherein the one or more virtual partitions are configured to store application data corresponding to one or more applications.

7. The system of claim 1, wherein the respective endurance threshold is a respective terabytes written (TBW) limit or a respective program/erase cycle limit,
wherein the first endurance parameter is a quantity of TBW to the respective virtual partition or a quantity of program/erase cycles performed on the respective virtual partition, and
wherein the initial endurance limit is an initial TBW limit or an initial program/erase cycle limit.

8. The system of claim 1, wherein the second endurance parameter is a valley margin between pairs of adjacent programming distributions of the wear-leveling media pool,
wherein the second endurance parameter is a total quantity of error detection and correction operations performed on the wear-leveling media pool, or
wherein the second endurance parameter is a total quantity of errors detected within the wear-leveling media pool.

9. The system of claim 1, wherein each virtual partition of the plurality of virtual partitions is assigned a different subset of logical memory addresses.

10. The system of claim 1, wherein the plurality of virtual partitions includes one or more first virtual partitions configured to store system data associated with a host device and one or more second virtual partitions configured to store non-system data associated with the host device, and
wherein the controller is configured to allocate the additional endurance amount among at least one of the one or more second virtual partitions to increase the respective endurance threshold of the at least one of the one or more second virtual partitions.

11. The system of claim 1, wherein the controller is configured to:
divide the wear-leveling media pool into the plurality of virtual partitions, including a first subset of one or more first virtual partitions configured to store system data associated with a host device and a second subset of one or more second virtual partitions configured to store non-system data associated with the host device,
assign each virtual partition of the plurality of virtual partitions a respective endurance threshold, and
allocate the additional endurance amount among the second subset of one or more second virtual partitions to increase the respective endurance threshold of at least one of the one or more second virtual partitions.

12. The system of claim 11, wherein the controller is configured to maintain the respective endurance threshold of each of the one or more first virtual partitions at a respective fixed value.

13. A system, comprising:
a non-volatile memory configured with a wear-leveling media pool comprising a plurality of memory blocks,
wherein the wear-leveling media pool has an initial endurance limit,
wherein the wear-leveling media pool is divided into a plurality of virtual partitions, including a first subset of one or more first virtual partitions configured to store system data associated with a host device and a second subset of one or more second virtual partitions configured to store non-system data associated with the host device, and
wherein each virtual partition of the plurality of virtual partitions is assigned a respective endurance threshold; and
a controller configured to:
evaluate an endurance parameter of the wear-leveling media pool,
determine to increase the initial endurance limit of the wear-leveling media pool by an additional endurance amount based on the endurance parameter satisfying a memory endurance condition of the wear-leveling media pool, and
allocate the additional endurance amount to the second subset of one or more second virtual partitions to increase the respective endurance threshold of at least one of the one or more second virtual partitions.

14. The system of claim 13, wherein the controller is configured to maintain the initial endurance limit of the wear-leveling media pool based on the endurance parameter not satisfying the memory endurance condition of the wear-leveling media pool.

15. The system of claim 13, wherein the respective endurance threshold is a respective terabytes written (TBW) limit or a respective program/erase cycle limit, and
wherein the initial endurance limit is an initial TBW limit or an initial program/erase cycle limit.

16. The system of claim 13, wherein the controller is configured to evaluate the endurance parameter of the wear-leveling media pool by evaluating a memory endurance of the plurality of memory blocks.

17. The system of claim 13, wherein the controller is configured to allocate the additional endurance amount to the second subset of one or more second virtual partitions such that a weighted average of the respective endurance thresholds of the plurality of virtual partitions matches a sum of the initial endurance limit and the additional endurance amount.

18. A method, comprising:
determining, by a controller of a memory device, that an endurance parameter associated with a wear-leveling media pool of the memory device satisfies a memory endurance condition of the wear-leveling media pool,
wherein the wear-leveling media pool has an initial endurance limit,
wherein the wear-leveling media pool is divided into a plurality of virtual partitions, including a first subset of one or more first virtual partitions configured to store system data associated with a host device and a second subset of one or more second virtual partitions configured to store non-system data associated with the host device, and
wherein each virtual partition of the plurality of virtual partitions is assigned a respective endurance threshold;
determining, by the controller of the memory device, an additional endurance amount to be applied to the wear-leveling media pool in addition to the initial endurance limit based on the endurance parameter satisfying the memory endurance condition; and
allocating, by the controller of the memory device, the additional endurance amount to the second subset of one or more second virtual partitions to increase the respective endurance threshold of at least one of the one or more second virtual partitions.

19. The method of claim 18, wherein the respective endurance threshold is a respective terabytes written (TBW) limit or a respective program/erase cycle limit, and
wherein the initial endurance limit is an initial TBW limit or an initial program/erase cycle limit.

20. The method of claim 18, wherein the endurance parameter is a valley margin between pairs of adjacent programming distributions of the wear-leveling media pool,
wherein the endurance parameter is a total quantity of error detection and correction operations performed on the wear-leveling media pool, or
wherein the endurance parameter is a total quantity of errors detected within the wear-leveling media pool.
